(19) United States
(12) Patent Application Publication
(10) Pub. No.: US 2012/0286622 A1
(43) Pub. Date: Nov. 15, 2012

(54) Spindle motor

(75) Inventors: Sang Won Kim, Gunpo (KR); Yong Sik Kim, Suwon (KR); Dong Hyun Lee, Seoul (KR)

(73) Assignee: SAMSUNG ELECTRO-MECHANICS CO., LTD., Suwon (KR)

(21) Appl. No.: 13/200,862

(22) Filed: Oct. 4, 2011

(30) Foreign Application Priority Data
May 13, 2011 (KR) 10-2011-0044964

(51) Int. Cl. H02K 1/18

(52) U.S. Cl. 310/216.113

(57) ABSTRACT

There is provided a spindle motor including: a base member including a sleeve housing having a sleeve inserted thereinto and mounted therein; a stator core mounted in the sleeve housing; and support parts improving horizontality of the stator core when the stator core is mounted in the sleeve housing.

### CROSS-REFERENCE TO RELATED APPLICATIONS

This application claims the priority of Korean Patent Application No. 10-2011-0044964 filed on May 13, 2011, in the Korean Intellectual Property Office, the disclosure of which is incorporated herein by reference.

### BACKGROUND OF THE INVENTION

1. Field of the Invention

The present invention relates to a spindle motor, and more particularly, to a spindle motor including a stator core.

2. Description of the Related Art

A hard disk drive (HDD), an information storage device, reads data stored on a disk or writes data to the disk using a read/write head.

The hard disk drive requires a disk driving device capable of driving the disk. As the disk driving device, a small-sized motor is used.

In addition, the above-mentioned motor includes the disk mounted thereon. The data stored on the disk is read at the time of rotation of the disk.

Here, the motor rotating the disk, which is a device converting electrical energy into mechanical energy using force applied to a conductor having a current flowing therein within a magnetic field, basically generates driving force rotating the disk through electromagnetic interaction between a magnet and a coil.

Meanwhile, the coil is wound around a stator core, and the stator core is mounted in a base member so as to be disposed to face a magnet. That is, the stator core is fixedly mounted in a sleeve housing of the base member so as to be disposed to face the magnet.

However, when the stator core is mounted in the sleeve housing, it may be inclinedly mounted therein. In this case, the centers of the stator core and the magnet do not coincide with each other. Therefore, cogging torque is unbalanced, such that noise distribution may be greater at the time of driving a motor.

### SUMMARY OF THE INVENTION

An aspect of the present invention provides a spindle motor in which horizontality of a stator core is improved at the time of mounting the stator core.

According to an aspect of the present invention, there is provided a spindle motor including: a base member including a sleeve housing having a sleeve inserted thereinto and mounted thereon; a stator core mounted in the sleeve housing; and support parts improving horizontality of the stator core when the stator core is mounted in the sleeve housing.

The stator core may include: a ring shaped coreback mounted on an outer peripheral surface of the sleeve housing; a plurality of extension parts extended from the coreback; and expansion parts extended from the extension parts and expanded in a circumferential direction, and wherein the support parts are extended from bottom surfaces of the expansion parts, such that tips thereof contact the base member.

The spindle motor may further include a pulling plate mounted in the base member so as to be disposed under a magnet disposed to face the stator core, wherein the support parts are extended upwardly from the pulling plate in an axial direction or are fixedly mounted in the pulling plate.

The base member may include a mounting part having the pulling plate mounted thereon, and the pulling plate may include a bent part contacting a sidewall forming the mounting part.

The pulling plate may include a ring shaped body, the bent part extended upwardly from an outer circumference of the body, and the support parts extended upwardly from an inner diameter part of the body in the axial direction.

The support parts may be provided in an inner diameter part of the pulling plate while being disposed to be spaced apart from each other in a circumferential direction.

The pulling plate may further include partition wall parts disposed between the support parts and extended so as to be disposed between winding coils wound around the stator core.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a spindle motor according to an embodiment of the present invention;

FIG. 2 is a bottom perspective view showing a stator core according to an embodiment of the present invention;

FIG. 3 is a cross-sectional view schematically showing a spindle motor according to another embodiment of the present invention;

FIG. 4 is a perspective view showing a pulling plate included in a spindle motor according to another embodiment of the present invention; and

FIG. 5 is a perspective view showing a pulling plate included in a spindle motor according to another embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, when it is determined that the detailed description of the known art related to the present invention may obscure the gist of the present invention, the detailed description thereof will be omitted.

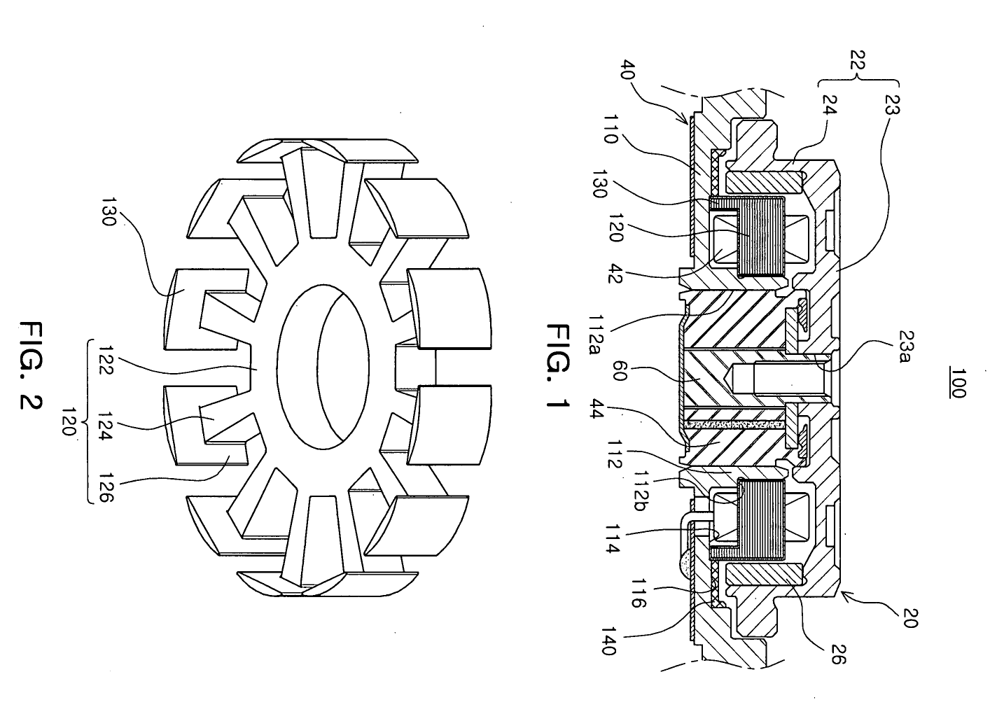

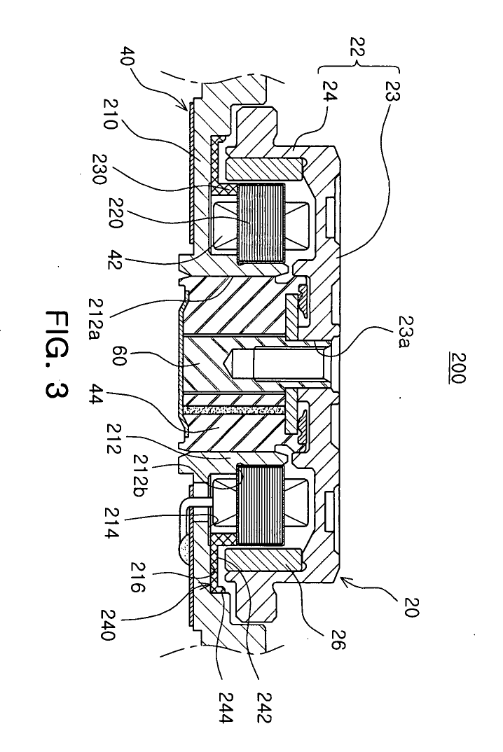

FIG. 1 is a cross-sectional view schematically showing a spindle motor according to an embodiment of the present invention; and FIG. 2 is a bottom perspective view showing a stator core according to an embodiment of the present invention.

Referring to FIGS. 1 and 2, a spindle motor 100 according to an embodiment of the present invention may include a base member 110, a stator core 120, and support parts 130.

Meanwhile, the spindle motor 100 may be a motor used in a recording disk driving device rotating a recording disk, and include a rotor 20 and a stator 40.

The rotor 20 may include a cup-shaped rotor case 22 in which an annular ring shaped magnet 26 corresponding to the stator core 120 is mounted. The annular ring shaped magnet 26 may be a permanent magnet generating magnetic force having a predetermined strength by alternately magnetizing an N pole and a S pole thereof in a circumferential direction.

In addition, the rotor case 22 may include a body 23 having an mounting hole 23a formed therein, the mounting hole being mounted on a shaft 60, and a magnet coupling part 24 extended downwardly from an edge of the body 23 in an axial direction.

Further, the magnet coupling part 24 may include the magnet 26 mounted on an inner surface thereof.

The stator 40, which means all fixing members with the exception of a rotating member, may include the stator core 120, a winding coil 42 wound around the stator core 120, a sleeve 44, and the base member 110.

Meanwhile, the magnet 26 mounted on the inner surface of the magnet coupling part 24 is disposed to face the stator core 120 having the winding coil 42 wound therearound, and the rotor 20 rotates due to interaction between magnetic force from the magnet 26 and electric force by a current supplied to the winding coil 42, in other words, electromagnetic interaction.

That is, the rotor case 22 rotates due to the interaction between the magnetic force from the magnet 26 and the electric force by the current supplied to the winding coil 42 and the shaft 60 rotates together with the rotor case 22.

Here, terms with respect to directions will be defined. As viewed in FIG. 1, an axial direction refers to a vertical direction based on the shaft 60, a radial direction refers to a direction towards an outer edge of the rotor case 22 based on the shaft 60 or a direction towards the center of the shaft 60 based on the outer edge of the rotor case 22, and a circumferential direction refers to a rotation direction along an outer peripheral surface of the shaft 60.

The base member 110 includes a sleeve housing 112 having the sleeve 44 inserted thereinto and mounted therein. The sleeve housing 112 may be extended upwardly in the axial direction, and include a mounting hole 112a such that the sleeve 44 may be inserted thereinto. That is, the sleeve housing 112 may have a cylindrical shape.

In addition, the sleeve 44 may be fixedly mounted to the sleeve housing 112 by an adhesive. That is, the adhesive is applied to an outer peripheral surface of the sleeve 44 and an inner peripheral surface of the sleeve housing 112, such that the sleeve 44 may be fixedly mounted to the sleeve housing 112.

Meanwhile, the sleeve housing 112 may include a seat part 112b formed on an outer peripheral surface thereof, the seat part 112b including the stator core 120 seated thereon. That is, the stator core 120 may be fixedly mounted on the outer peripheral surface of the sleeve housing 112 in a state in which the stator core 120 is seated on the seat part 112b.

In addition, the base member 110 may include a coil disposing part 114 disposed on an outer portion of the sleeve housing 112. Further, the coil disposing part 114 may include a mounting part 116 formed on an outer portion thereof, the mounting part 116 being formed in a stepped manner from a bottom surface of the coil disposing part 114 so as to have a pulling plate 140 mounted thereon.

The stator core 120 is mounted in the sleeve housing 112, as described above.

Meanwhile, the stator core 120 may include a ring shaped coreback 122 mounted on the outer peripheral surface of the sleeve housing 112, a plurality of extension parts 124 extended from the coreback 122, and expansion parts 126 extended from the extension parts 124 and expanded in the circumferential direction, as shown in more detail in FIG. 2.

In other words, the coreback 122 is coupled to the sleeve housing 112 such that a bottom surface thereof is seated on the seat part 122b formed on the outer peripheral surface of the sleeve housing 112. Here, an adhesive is applied to an inner peripheral surface of the coreback 122 and the outer peripheral surface of the sleeve housing 112, such that the coreback 122 and the sleeve housing 112 may be coupled to each other.

In addition, the extensions part 124 may have a bar shape so as to have the wiring coil 42 wound therearound.

When the stator core 120 is mounted in the sleeve housing 112, the support parts 130 improve horizontality of the stator core 120.

The support part 130 is extended from a bottom surface of the expansion part 126, such that a tip thereof contacts the bearing member 110. In other words, the support part 130 is formed integrally with the expansion part 126, and have the tip contacting the coil disposing part 114 of the base member 110 when the coreback 122 is seated on the seat part 122b of the sleeve housing 122.

Therefore, when the stator core 120 is mounted in the sleeve housing 122, the horizontality of the stator core 120 may be improved. That is, the coreback 122 is seated on the seat part 112b of the sleeve housing 112, such that the stator core 120 is primarily disposed horizontally. Furthermore, the tip of the support part 130 contacts the base member 110, such that the horizontality of the stator core 120 may be secondarily improved.

Here, the horizontality indicates a degree in which the stator core 120 is disposed in parallel with an upper surface of the base member 110.

As described above, since the stator core 120 may be constantly supported on the base member 110 by the support part 130, height deviation and horizontality distribution of the stator core 120 may be improved.

In addition, since the horizontality of the stator core 120 may be improved, cogging torque is improved, whereby noise generation may be reduced.

Hereinafter, a spindle motor according to another embodiment of the present invention will be described with reference to the accompanying drawings.

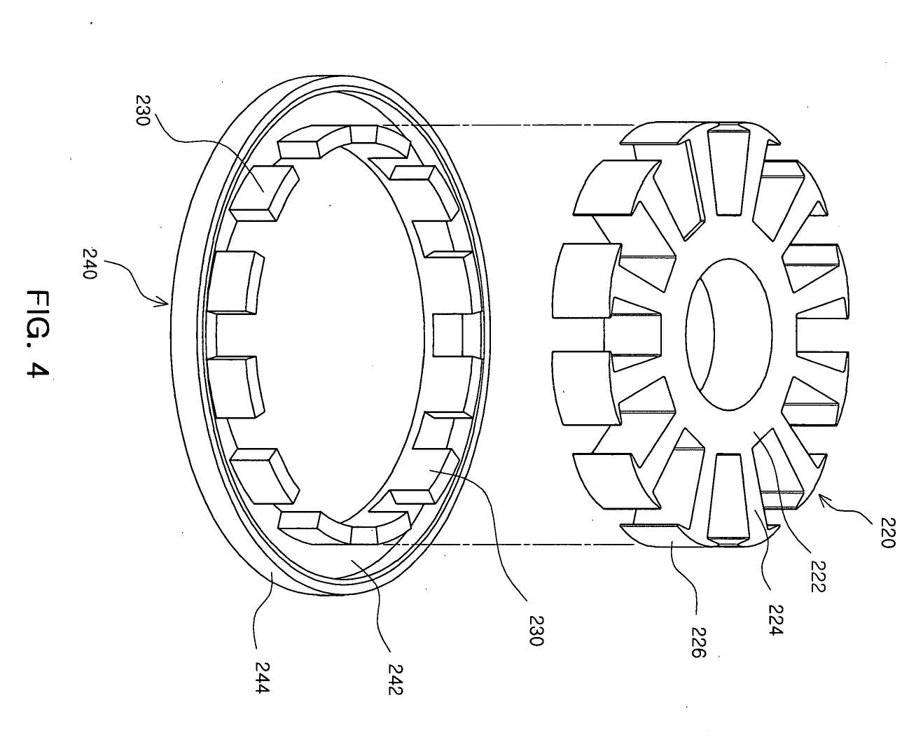

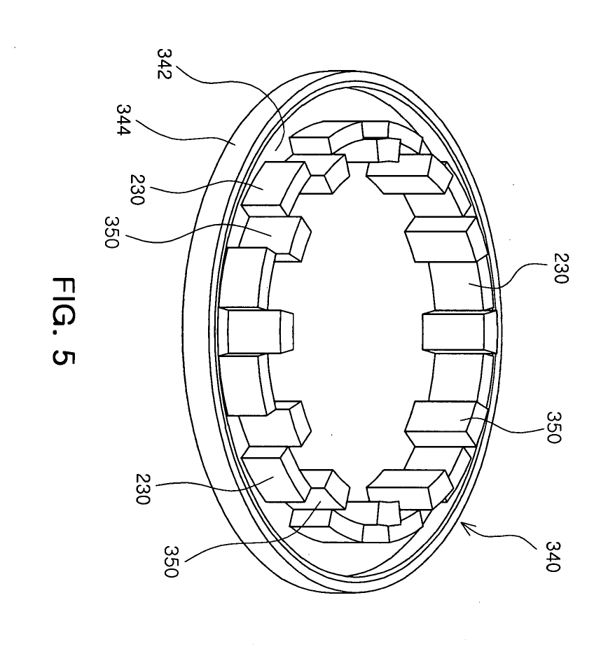

FIG. 3 is a cross-sectional view schematically showing a spindle motor according to another. embodiment of the present invention; and FIG. 4 is a perspective view showing a pulling plate included in a spindle motor according to another embodiment of the present invention.

Referring to FIGS. 3 and 4, a spindle motor 200 according to another embodiment of the present invention may include a base member 210, a stator core 220, support parts 230, and a pulling plate 240.

The base member 210 has the same configuration as that of the base member 110 included in the spindle motor 100 according to the embodiment of the present invention. Therefore, a detailed description thereof will be omitted.

That is, the base member 210 may include a sleeve housing 212 having a sleeve 44 inserted into and mounted therein, and the sleeve housing 212 may include a seat part 212b formed on an outer peripheral surface thereof, the seat part 212b including the stator core 220 seated thereon.

In addition, the base member 210 may include a coil disposing part 214 and a mounting part 216.

Meanwhile, the stator core 220 is mounted in the sleeve housing 212.

Meanwhile, the stator core 220 may include a ring shaped coreback 222 mounted on an outer peripheral surface of the sleeve housing 212, a plurality of extension parts 224 extended from the coreback 222, and expansion parts 226 extended from the extension parts 224 and expanded in the circumferential direction.

In other words, the coreback 222 is coupled to the sleeve housing 212 such that a bottom surface thereof is seated on the seat part 212b formed on the outer peripheral surface of the sleeve housing 212. Here, an adhesive is applied to an inner peripheral surface of the coreback 222 and the outer peripheral surface of the sleeve housing 212, such that the coreback 222 and the sleeve housing 212 may be coupled to each other.

In addition, the extension part 224 may have a bar shape so as to have the wiring coil 42 wound therearound, and the expansion part 226 is disposed to face the annular ring shaped magnet 26 mounted in the rotor case 22.

When the stator core 220 is mounted in the sleeve housing 212, the support parts 230 improve horizontality of the stator core 220. A detailed description of the support parts 230 will be provided below.

The pulling plate 240 is mounted in the base member 210 in such a manner as to be disposed under the magnet 26 disposed to face the stator core 220.

That is, the pulling plate 240 is fixedly mounted in the mounting part 216 of the base member 210 and is disposed under the magnet 26. Therefore, excessive floating of the rotor case 22 may be prevented at the time of rotation of the rotor case 22.

Meanwhile, the pulling plate 240 may include a ring shaped body 242, a bent part 244 extended upwardly from an outer circumference of the body 242, and the support parts 230 extended upwardly in the axial direction from an inner diameter part of the body 242.

That is, when the pulling plate 240 is mounted in the base member 210, a bottom surface of the body 242 contacts a bottom surface of the mounting part 216, and the bent part 244 contacts a sidewall forming the mounting part 216.

In addition, the pulling plate 240 may be fixedly mounted to the base member 210 by the adhesive.

Meanwhile, the inner diameter part of the body 242 may be disposed under the expansion parts 226 of the stator core 220.

In addition, the support part 230 may be formed integrally with the pulling plate 240. When the stator core 220 is mounted in the sleeve housing 212, a bottom surface of the expansion part 226 of the stator core 220 may be supported by the support part 230.

Meanwhile, the support parts 230 may be provided in plural and may be disposed to be spaced apart from each other in the circumferential direction in such a manner that they correspond to the expansion parts 226 of the stator core 220.

However, although the present embodiment describes a case in which the support parts 230 are formed integrally with the pulling plate 240, the support parts 230 may be formed separately from the pulling plate 240 and then be fixedly mounted to the pulling flate 240.

As described above, when the stator core 220 is mounted in the sleeve housing 212, the horizontality of the stator core 220 may be improved. That is, the coreback 222 is seated on the seat part 212b of the sleeve housing 212, such that the stator core 220 is primarily disposed horizontally. Furthermore, the support parts 230 extended from the pulling plate 240 support the bottom surface of the expansion parts 226 of the stator core 220, such that the horizontality of the stator core 220 may be further improved.

Since height deviation and horizontality distribution of the stator core 220 may be improved as described above, cogging torque is improved, whereby noise generation may be reduced.

Hereinafter, a spindle motor according to another embodiment of the present invention will be described with reference to the accompanying drawings. However, a spindle motor according to another embodiment of the present invention has the same components as those of the spindle motor according to the embodiment of the present invention, with the exception of a pulling plate. Therefore, only the pulling plate will be shown in the following drawing and will be described below. In addition, the same reference numerals will be used to describe the same component as the components of the spindle motor according to the embodiment of the present invention.

FIG. 5 is a perspective view showing a pulling plate included in a spindle motor according to another embodiment of the present invention.

Referring to FIGS. 3 to 5, a pulling plate 340 is mounted in the base member 210 in such a manner as to be disposed under the magnet 26 disposed to face the stator core 220.

In addition, the pulling plate 340 may include a ring shaped body 342, a bent part 344 extended upwardly from an outer circumference of the body 342, and the support parts 230 extended upwardly in the axial direction from an inner diameter part of the body 342.

Meanwhile, the pulling plate 340 may further include partition wall parts 350 disposed between the supports 230 and extended so as to be disposed between the winding coil 42 provided in plural and wound around the stator core 220.

The partition wall parts 350 may be extended from the inner diameter part of the pulling plate 340 so as to be disposed inside the support part 230 in the radial direction. Therefore, when the stator core 220 is mounted in the sleeve housing 212, the partition wall parts 350 may be disposed between the plurality of winding coils 42 wound around the stator core 220.

Therefore, positions of the respective winding coils 42 may be fixed by the partition wall parts 350. Furthermore, air flow under the stator core 220 is blocked by the partition walls 350, such that noise generated by the air flow may be further reduced.

As set forth above, according to the embodiments of the present invention, the bottom surface of the stator core could be supported by the support parts, whereby the horizontality of the stator core could be improved. Therefore, noise generated during the driving of the motor may be reduced.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a base member including a sleeve housing having a sleeve inserted thereinto and mounted therein;
a stator core mounted in the sleeve housing; and
support parts improving horizontality of the stator core when the stator core is mounted in the sleeve housing.

2. The spindle motor of claim 1, wherein the stator core includes:
a ring shaped coreback mounted on an outer peripheral surface of the sleeve housing;
a plurality of extension parts extended from the coreback; and
expansion parts extended from the extension parts and expanded in a circumferential direction, and
wherein the support parts are extended from bottom surfaces of the expansion parts, such that tips thereof contact the base member.

3. The spindle motor of claim 1, further comprising a pulling plate mounted in the base member so as to be disposed under a magnet disposed to face the stator core,
wherein the support parts are extended upwardly from the pulling plate in an axial direction or are fixedly mounted in the pulling plate.

4. The spindle motor of claim 3, wherein the base member includes a mounting part having the pulling plate mounted thereon, and the pulling plate includes a bent part contacting a sidewall forming the mounting part.

5. The spindle motor of claim 4, wherein the pulling plate includes a ring shaped body, the bent part extended upwardly from an outer circumference of the body, and the support parts extended upwardly from an inner diameter part of the body in the axial direction.

6. The spindle motor of claim 5, wherein the support parts are provided in an inner diameter part of the pulling plate while being disposed to be spaced apart from each other in a circumferential direction.

7. The spindle motor of claim 6, wherein the pulling plate further includes partition wall parts disposed between the support parts and extended so as to be disposed between winding coils wound around the stator core.
